(19) United States
(12) Patent Application Publication
(10) Pub. No.: US 2004/0216488 A1
(43) Pub. Date: Nov. 4, 2004

(54) Method and device for producing a glass blank

(76) Inventor: Ulrich Zirfas, Bad Gandershiem (DE)

Correspondence Address: Todd T Taylor, Taylor & Aust, 142 South Main Street, PO Box 560, Avilla, IN, 46710, US

(21) Appl. No.: 10/481,774

(22) PCT Filed: Jun. 24, 2002
(86) PCT No.: PCT/EP02/06949

(30) Foreign Application Priority Data
Jun. 23, 2001 (DE) 101 30 394.7

(51) Int. Cl. C03B 11/16; C03B 11/02

(52) U.S. Cl. 65/77; 65/223; 65/226; 65/309; 65/320

(57) ABSTRACT

A method and a device whereby optical glass articles can be produced economically and can be reproduced at a high level of contour accuracy and surface quality. The cost effective press technology that is suitable for mass production is maintained, while at the same time, avoiding the associated disadvantages. A multi-phase press process is utilized whereby the final geometry of the blank is achieved iteratively. Accordingly, a pre-blank is produced from a gob of glass that is fed by way of a feeding device to a press device. The press device is a pre-press including a pre-press punch. The pre-press device produces a blank whose geometry, while coming close, does not yet correspond with the desired final geometry. This first press step is followed by a second one, whereby the pre-blank is transformed into the end product. The press process is broken down into two individual press steps.

### BACKGROUND OF THE INVENTION

1. Field of the Invention

The present invention relates to the production of glass blanks by way of presses, and more particularly, blanks of the types for application in the optical field, for example, reflectors, lenses or suchlike.

2. Description of the Related Art

Reflectors are known from DE-A-199 10 192. DE-A 100 62 187 relates to glass forms which may represent intermediate products in the overall production process for lenses.

With objects of this type, demands with regard to contour accuracy and surface quality are extremely high, such as in the μ-range. Deviations from the desired contour accuracy could result in aggravating optical drawbacks and may render the object useless.

Presses are used in the production of objects of the aforementioned type. A gob of glass is transferred from a feeder into a press device, including a press mold and a press punch, frequently also a cover ring. The transformation process, during which the press subject receives its final shape, occurs in the press device.

In the hitherto known methods and devices, the desired contour accuracy and surface quality are not achieved. This is because the temperature of the glass gob decreased during the press process, thereby leading to contractions. Undesirable deformations are associated with this, resulting in that the pressed article, after discharge, does not have the desired geometry. Heat is drawn from the blank by the press punch so that the temperature is lowered during the initial press process, thereby somewhat diminishing the contraction. However, the heat absorption by the press punch is not sufficient.

Attempts have also already been made to reduce the aforementioned detrimental effect by lowering the temperature of the glass at the discharge from the feeder and at the entry into the press device. This implies however, that the necessary specific press forces must be increased. This in turn leads to a high stress of the press device and thereby to fractures and increased wear and tear.

Attempts have also been made to compensate for the problem by over-sizing the nominal geometry of the mold cavity for the blank that is to be produced. This also has not been successful, since the blank cools down differently across its entire circumferential surface. The side facing the press mold cools down quicker than the side facing the press punch. On the punch side the glass mass is particularly hot and particularly soft, since the contact with the punch is relatively short. At any rate, highly precise blanks cannot be reproduced reliably with the known methods and devices.

What is needed in the art is a method and a device whereby optical glass articles can be produced economically and can be reproduced at a high level of contour accuracy and surface quality.

### SUMMARY OF THE INVENTION

The present invention provides, a method and a device whereby optical glass articles can be produced economically and can be reproduced at a high level of contour accuracy and surface quality.

The inventor of the present invention followed a path that permitted him to maintain the cost effective press technology that is suitable for mass production, while at the same time, avoiding the associated disadvantages. The fundamental concept includes the utilization of a multi-phase press process whereby the final geometry of the blank is achieved iteratively. Accordingly, a pre-blank is produced from a gob of glass that is fed by way of a feeding device to a press device. The press device is a pre-press including a pre-press punch. The pre-press device produces a blank whose geometry, while coming close, does not yet correspond with the desired final geometry.

This first press step is followed by a second one, whereby the pre-blank is transformed into the end product. It could also be said that the press process is broken down into two individual press steps.

This provides a perfect solution, a device and method whereby optical glass articles can be produced economically and can be reproduced at a high level of contour accuracy and surface quality. The present invention however, also has the following advantages. During the first press process that occurs in the pre-press, the glass temperature may be higher, thereby minimizing the influences of the normally lower glass temperatures. The level of transformation of the pre-blank in the subsequent end-press device is exceptionally small. Because of this, the end forming process can be carried out at a relatively low temperature of the pre-blank. Possibly occurring deviations from the desired contour are only minimal in the final blank.

The entire press process can also be divided into three or more individual press steps, so that more than one pre-press device is provided.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a partly sectional, front view of an embodiment of a device for the production of a glass blank according to the present invention; and

FIG. 2 is a top view of the device of FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

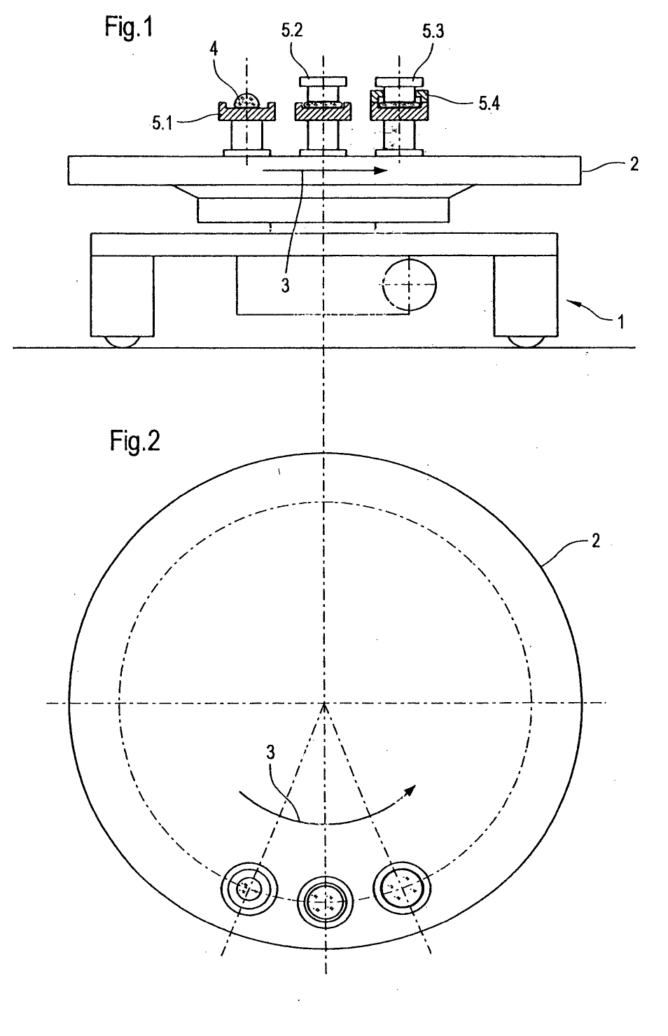

Referring now to the drawings, and more particularly to FIG. 1, there is shown a device according to the present invention which includes a press 1, which can be fully automatic, semi-automatic or manual. Press 1 is equipped, for example, with a rotary table 2. This rotates step by step, in other words always by a certain angle, according to arrow 3.

Around its circumference table 2 is equipped with press molds. Each of these includes a sub-mold 5.1. Three stations, namely I, II, III, are depicted. In station I a gob of glass 4 is shown in a sub-mold 5.1. In station II a pre-press device 5.2 is illustrated which presses the gob of glass 4, thereby giving it its initial shape as a pre-blank 4.1. In station III the actual press device 5.3 (end-press device) is shown, as well as a top mold 5.4. This is where the blank 4.2 receives its final shape.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-4 (Canceled)

5. A method for the production of a glass blank, comprising the steps of:
transferring a gob of glass into one of a pre-press mold and a press mold;
assigning a press punch to said one of a pre-press mold and a press mold;
transforming said gob of glass in said one of a pre-press mold and a press mold into a pre-blank that at least approximately assumes a final nominal geometry of a blank; and
subjecting said pre-blank to an end-press process by way of an end-press device, said end-press device including an end-press and an end-press punch.

6. The method of claim 5, further including at least one pressing-process step, said at least one pressing-process step intermediate said transforming step and subjecting step, said at least one pressing-process step occurring between said transforming step and subjecting step.

7. The method of claim 5, a glass temperature is lowered in each subsequent step of said method.

8. A device for the production of a glass blank, comprising:
a feeder device station for producing a gob of glass;
a pre-press device station including a pre-press mold and a pre-press punch, said pre-press device station accepting said gob of glass from said feeder device station for forming a pre-blank; and
an end-press device station including an end press-mold and an end-press punch, said end-press device station transforming said pre-blank into a blank possessing a nominal geometry.
